(19) United States
(12) Patent Application Publication
(10) Pub. No.: US 2006/0081135 A1
(43) Pub. Date: Apr. 20, 2006

(54) Industrial overline imaging system and method

(76) Inventors: Douglas F. Britton, Alpharetta, GA (US); Wayne Daley, Snellville, GA (US); John Stewart, Atlanta, GA (US); Bonnie S. Heck-Ferri, Atlanta, GA (US); George Vachtsevanos, Marrietta, GA (US)

Correspondence Address: Kenneth W. Float, 2095 Hwy. 211 NW, #2F, Braselton, GA, 30517, US

(21) Appl. No.: 11/204,138

(22) Filed: Aug. 15, 2005

Related U.S. Application Data
(60) Provisional application No. 60/601,875, filed on Aug. 16, 2004.

(51) Int. Cl. B23Q 15/00

(52) U.S. Cl. 99/486

(57) ABSTRACT

Disclosed are product inspection systems and methods for monitoring, inspecting and controlling baking and cooking processes, and the like. Products are processed in a predetermined manner using a product processor, such as by baking the products, for example. A controller is used to control operation of the product processor. A conveyor moves or conveys processed products past inspection apparatus. The inspection apparatus comprises an image acquisition system for generating images of products conveyed by the conveyor past the inspection apparatus. One or more illumination devices illuminate products on the conveyor. An inspection processor processes images generated by the image acquisition system to inspect the conveyed products. The inspection processor determines locations of conveyed products by processing image data corresponding to the image frames, and classifies each of the located products to indicate if the products are acceptable or are defective. A kickoff device is coupled to the inspection processor for removing product from the conveyor. The inspection processor controls the kickoff device to remove the defective products.

### BACKGROUND

The present invention relates generally to industrial overline systems and methods, and more particularly, to automated vision-based systems and methods for monitoring, inspecting and controlling baking and cooking processes.

The bakery industry is the second largest segment of Georgia's food processing industry (estimated 17% by sales volume) with operations located throughout the state. One of the active and growing market segments is the production of buns and rolls for food service and fast food customers. A growing number of these customers (Arby's, Wendy's, Burger King, McDonald's, for example) are placing increasing demands on quality control for bun size, shape, color, and topping coverage (sesame seeds, etc.). The U.S. baking industry has met the challenge of increased production levels by employing modern automated high-volume baking systems (with production capacity on the order of 1000 buns per minute). The conventional inspection process is for workers to remove a few samples of the product each hour and to inspect them manually against customer specifications. Customers are pushing for a more accurate and uniform assessment process. There is no existing system that provides feedback to control the baking/cooking process.

In today's competitive baking environment, bakeries are faced with the growing need to monitor product quality on a continuous basis to control product consistency and uniformity. Foodservice and fast food chains are demanding higher product quality and consistency for the bread products they purchase. Subtle differences in the size, color, texture and seed coverage can cause a large fast food chain to consider taking its business elsewhere. In 1997 the baking industry contributed $394 million in value added manufacturing to Georgia's economy on shipments totaling more than $617 million. Second only to white pan bread, roll and bun production made up over 28% of this output with an average annual growth of over 10% over the previous five-year period.

The need to produce a consistent product through shift changes, daily and seasonal temperature and humidity changes, and variations in ingredients is the motivation for exploring advanced quality monitoring and control systems for commercial bakeries. Affordable, responsive, on-line product imaging is one technology area that continues to elude the needs of this industry. Dipix Technologies has developed computer-vision inspection machines that inspect product samples off-line (See Dipix Technologies website, http://www.dipix.com/). While this does remove some of the subjectivity of manual inspection by workers, it does not address the issue of 100% inspection nor the important issue of intelligent controls. The use of product images for automated control of the baking process is desired by customers, but heretofore has not been available.

U.S. patent application Ser. No. 20040206248 entitled “Browning control” published Oct. 21, 2004, discloses “A browning control specifically for use with toasters but which can also be used in other applications such as ovens in which the original colour of the item (20) to be browned is ascertained, the required colour for the article (20) is selected by a user and the change of colour of the article is monitored (50, 51, 52) until it reaches the required colour at which time the article (20) is ejected or the power courting the browning is removed.” (see Abstract). However, nothing is disclosed or suggested in this application regarding a real-time, on-line monitoring, inspection and control system employed with an industrial, conveyor-type baking or cooking process.

It would be desirable to have automated vision-based systems and methods that monitor, inspect and control baking and cooking processes, and the like.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates an exemplary embodiment of an industrial overline system;

FIG. 1a illustrates another exemplary embodiment of the industrial overline system;

FIG. 2 illustrates details of processing performed in the exemplary industrial overline system;

FIG. 3 illustrates processing to determine bun location;

FIG. 4 illustrates processing to determine bun shape;

FIG. 5 illustrates processing to detect defects;

FIG. 6 is a graph that illustrates statistics regarding exemplary bun color grades;

FIGS. 7-9 illustrate additional details of the exemplary industrial over-line system; and

FIG. 10 illustrates an exemplary product inspection method.

### DETAILED DESCRIPTION

Described herein are industrial overline imaging systems and methods. The systems and methods may be employed to monitor, inspect and control baking and cooking processes, and the like. The systems and methods may also be used for other overline monitoring, inspection and control processes such as for raw and cooked meat and vegetables as well as package inspection. Exemplary systems and methods are described that monitor, inspect and control bun baking processes.

More specifically, disclosed is an on-line production line imaging and inspection system that automatically inspects buns and a control system that uses image information and oven data to actively and automatically control the baking processes. The system screens 100% of buns that are produced. This imaging inspection and control approach is novel in the baking industry, and provides for significant benefits including reduced processing costs, improved inspection and control performance, and increased yield.

The disclosed industrial bun production line inspection and control system comprises three major modules, including a vision-based on-line inspection system that monitors bun quality at the exit of an oven, a modeling framework that captures the distributed and coupled dynamics of heating zones in the oven, and an intelligent control strategy that optimizes the zone temperatures, conveyor speed, and damper fan set points to obtain the “best” product quality based on the machine vision quality indicators and the oven parameters.

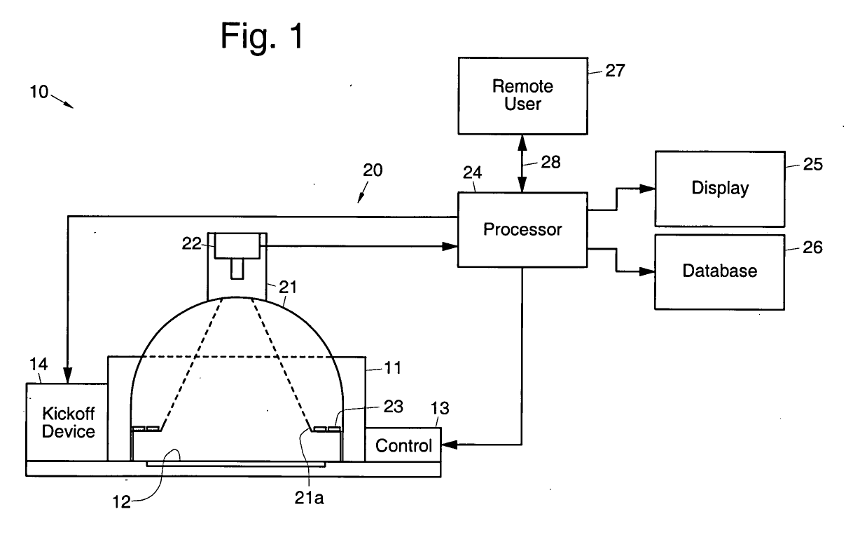

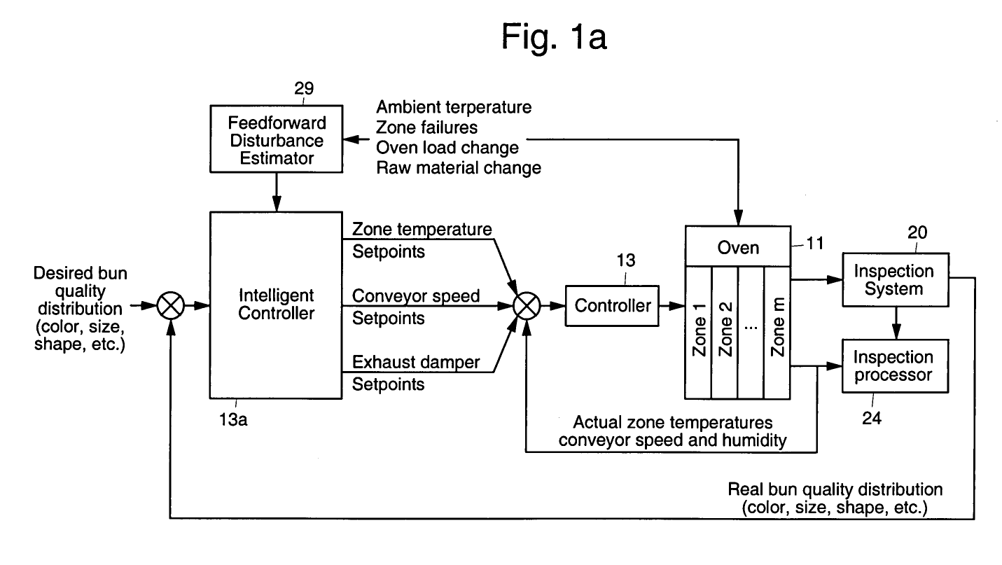

Referring to the drawing figures, FIG. 1 illustrates an exemplary industrial overline inspection and control system 10 for monitoring and controlling baking and cooking processes. The exemplary system 10 provides for a bread grading system 10, such as for grading hamburger buns, for example.

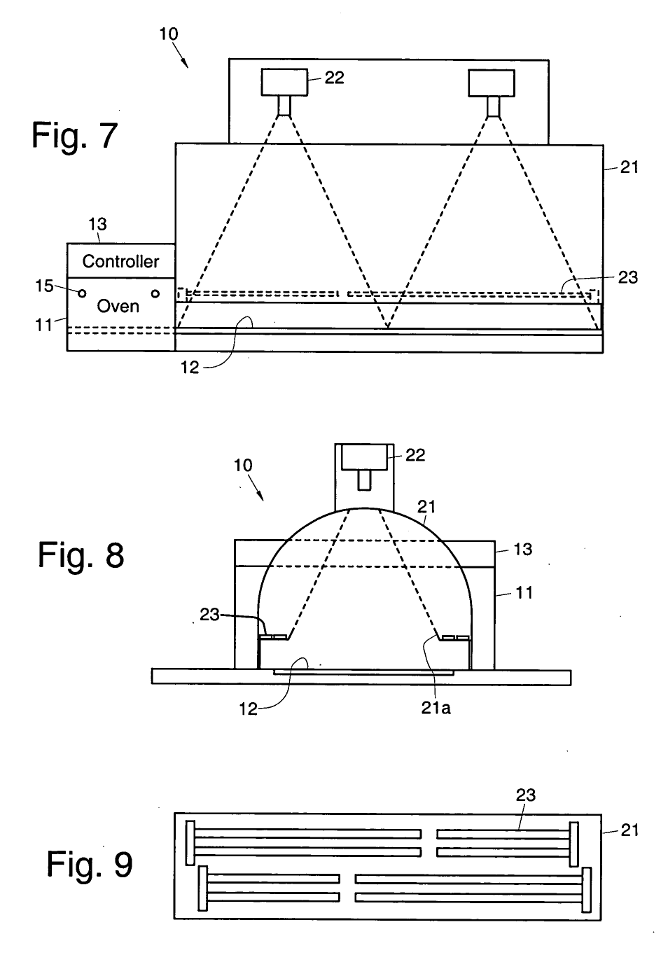

The exemplary bread grading system 10 is used with an oven 11 having a conveyor 12, an oven controller 13, and a kickoff device 14. The oven 11 may be referred to as a product processor. The oven 11 has multiple heating zones (FIG. 1a) that are controlled by the controller 13. Heat sensors 15 (FIG. 7) are coupled to the controller 13 to provide temperature feedback for control of the heating zones by the controller 13.

The exemplary bread grading system 10 comprises inspection apparatus 20 (inspection system 20) that includes a housing 21 that is disposed above the conveyor 12. One or more image acquisition systems 22 or cameras 22 are disposed in the housing 21 above the conveyor 12 that view buns that come out of the oven 11 moved by the conveyor 12. A lighting system 23 comprising one or more illumination devices 23 are disposed adjacent a lower part of the housing 21 to illuminate the conveyor 12 and buns disposed thereon. A plurality of baffles 21a are used to prevent direct illumination of buns by the illumination devices 23. The image acquisition systems 22 or cameras 22, generate images of the buns disposed on the moving conveyor 12 that pass through their field of view.

The image acquisition systems 11 or cameras 11 is coupled to a processor 24 (inspection processor 24). The processor 24 is coupled to a display 25, a database 26, and by way of a network 28 to remote users 27. The processor 24 is also coupled to the oven controller 13 and the kickoff device 14. The processor 24 is operative to process images generated by the cameras 11 to determine such things as bun location, bun color distribution (bake level uniformity), bun roundness, garnish cover (seeding score/count) and uniformity (seeding voids/distribution), total number of buns processed, number of buns per minute, percentage of defective buns, for example. The processor 24 is also operative to control the kickoff device 14 to remove defective buns, and control the temperatures of the oven heating zones to optimizes zone temperatures.

FIG. 1a illustrates another exemplary embodiment of the industrial overline system 10. This embodiment of the industrial overline system 10 provides for intelligent control functions that provide for an integrated vision inspection, process monitoring and control system. The system 10 shown in FIG. 1a adds a feedforward disturbance estimator 29 and an intelligent controller 13a to the system 10 shown in FIG. 1. it is to be understood, however, that the intelligent controller 13a may be integrated into the processor 24, if desired.

Bun quality information determined from images, along with oven variables such as zone temperatures, and additional relevant information such ambient conditions and material changes that may be obtained from a plant-wide monitoring system, are fed back by way of the feedforward disturbance estimator 29 to the intelligent controller 13a. The feedforward disturbance estimator 29 and intelligent controller 13a implement a predictive function that compensates for time delays, and a statistical function that controls the distribution of the quality for the product.

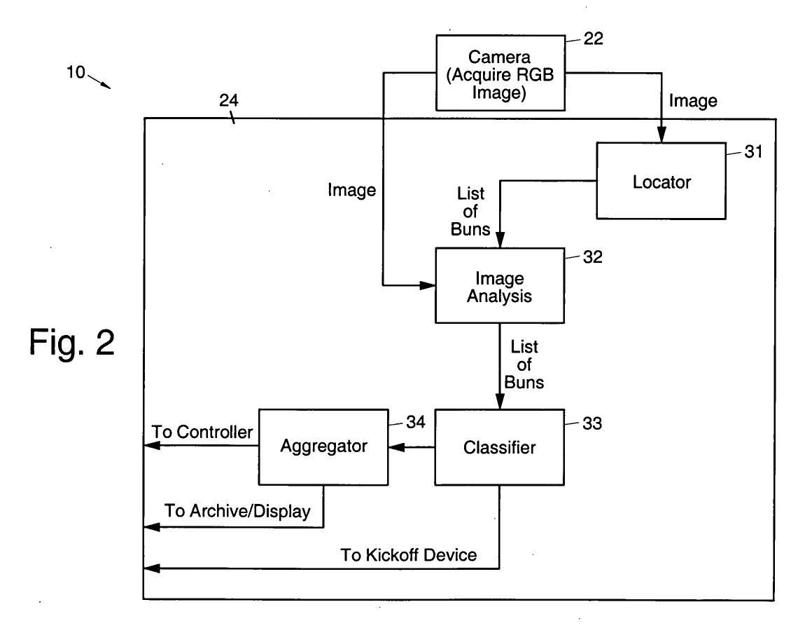

FIG. 2 illustrates details of processing performed in the exemplary bread grading system 10 and also illustrates a top level flow for processes implemented in the system 10. As is shown in FIG. 2, the camera 22 is coupled to the processor 24 and outputs image frames that are processed by software algorithms in the processor 24.

The software algorithms in the processor 24 include a locator 31 that determines locations of buns in image frames received from the camera 11 and outputs a list of buns (bun object). A image analyzer 32 processes the image frames and the list of buns (bun object) and preliminarily classifies and analyzes buns that were located by the locator 31. The image analyzer 32 outputs the list of buns (bun object) to a classifier 33. The classifier 33 is coupled to the kickoff device 14 and generates a control signal that causes the kickoff device 14 to remove defective buns from the conveyor 12 that are identified in the list of buns (bun object) that are processed by the classifier 33. The classifier 33 is coupled to an aggregator 16 that computes running statistical quantities and stores them in the database 26 (archive 26). The aggregator 16 is coupled to the display 25 which allows viewing of the images of buns conveyed by the conveyor 14 along with the statistics output by the aggregator 16. The aggregator 16 is also coupled to the controller 13 (or intelligent controller 13a) and outputs control parameters thereto (such as the setpoints identified in FIG. 1a) that provide real-time closed-loop control of the buns that are baked.

Thus, the image processing portion of the exemplary bread grading system 10 implements four primary aspects: image acquisition, bun location and extent, image analysis/classification and statistics aggregation. Once the image has been acquired by the camera 22 it is processed by the locator 31. The locator 31 finds all buns located completely within the image and for each bun it creates a bun object and adds it to a linked list of buns (bun object). The locator 31 specifies the center position of each bun and determines average diameter and roundness parameters and stores them in the bun object. Further analysis of the bun is performed by the classifier 32 wherein the entire surface of the bun is examined to determine bake level, garnish coverage, and defect related parameters. The results of this analysis are stored in the bun object. The classifier 32 is used to determine if a bun is bad or not. At this point, the system 10 knows if a bun should be rejected and the location of buns that should be rejected are passed into the kickoff device 14. The aggregator 34 computes running statistical quantities which are archived in the database 26. The aggregator 34 make present and past quantities available to user interfaces of the remote user 27 and external control systems (oven controller 13, kickoff device 14) as required.

The software algorithms are defined in terms of classes, which are well known to those in the programming art. Exemplary classes that are employed include: a camera class that contains all the items and functionality associated with configuring the cameras 11, an image class that contains image data and pointers to each row in the image, a bun class that stores data collected for each bun, a locator class that performs the scan line functions to locate all buns that are completely in an image, a filter class that filters data using a zero-phase FIR or IIR filter, for example, a process class that processes each bun and determines the level/presence of the specific attributes being measured on the product, a region class that contain the sub regions of each bun sub-image as separate images, an interface class that contains user configurable parameters and initialization routines, a logging class that logs errors, a system configuration class that contains system relevant data, and a product catalog configuration class that contains product rejection rules, for example.

The camera class is configured to capture single images and control camera properties. The camera class populates the image class with image data, and pointers to beginning of each row of the data. The image acquisition processing stage provides an image ready for processing by the locator 31 and further processing stages.

The camera 11 uses a camera interface to acquire a 24 bit RGB image and store it in an image object. The object allows access to the image array in terms of row (y) and column (x) indices with column indices changing the fastest, ex. image.bits[y][x]. The origin of the image is in the upper left. Exemplary cameras 11 that may be employed include low cost color web cameras using, higher cost three-chip color cameras, or preferably Point Grey Research (PGR) IEEE-1394 Dragonfly cameras. IEEE-1394 OHCI compliant 32 bit PCI cards that support up to three simultaneous connections may be used to interface the cameras 11 to the processor 12.

The camera 11 is configured so that, in the x direction, all buns are completely in the image. In other words, there are no partial buns on the vertical edges of the images (parallel to the direction of movement of the conveyor 12.

Inputs to the bun locator 31 are an image object from the image class, a bun ID function, thresholds, conveyor speed, and distances between scan lines. The primary output is a locator class that contains the linked list of all buns that are completely in the image field of view. Other outputs may include the radius and roundness parameters (min and max radius, mean radius, standard deviation of radius observations, for example) for each bun object in the list. The locator 31 does not modify the original image.

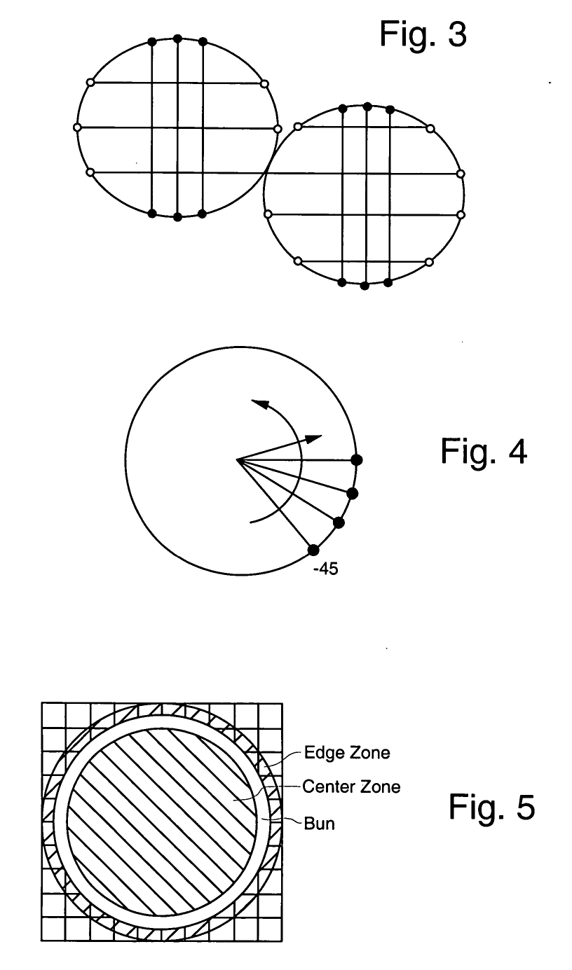

Referring to FIG. 3, it illustrates exemplary processing performed by the locator 31 to determine bun location. Different scan lines are shown in FIG. 3. The locator 31 finds line segments that represent bun pixels by applying the input bun ID function to horizontal scan lines. Each scan line is filtered using a Direct Form Type II filter (IIR filter, for example) to remove the background and then checked against a threshold to find segments that cross the buns. The locator 31 looks for segments on every R/2 scan lines, for example, to guarantee a scan line will cross the upper and lower half of the bun. Segments are not added unless they exceed a threshold length, and segments are ignored if they touch either edge of the image. At the completion of segmentation, the locator object contains an array of STL (standard template library) lists of line segment objects.

In a reduced to practice implementation, scan lines are created by subtracting a blue color value from a red color value down and entire column of the image. The filter is then run on the scan line. Finally, the scan line is compared to a threshold to determine what part of the entire line lies within a bun, if any of it. This part is separated into a line segment to be processed as discussed below.

The next step converts this collection of line segments into bun locations and radii. In this step, the center point of each line segment is computed. A segment is then formed from the center of the line vertically to the top and bottom edges of the bun. Two additional vertical segments are formed parallel to the first at a predefined offset, as shown in FIG. 3.

In the next step, the locator 31 uses the vertical lines to determine which line segments may be part of the bun. Like the segments, a vertical line is not used unless it exceeds a threshold length, and is ignored if it touches either edge of the image. The center of each segment crossing the vertical lines is compared to the center of the first segment. If the centers line up within a set tolerance, the segment's endpoints are added to a list. They are then removed from the list of segments to examine.

If the centers do not line up, this is an indication that the segment crosses multiple buns, and more processing is necessary. The expected endpoints of the segment are calculated based on the segment's location relative to the center of the bun and the given radius. If either end extends beyond what was predicted, the segment is truncated. If both ends extend beyond the predicted length, the segment is subdivided into two different segments. Any endpoints that were not modified are added to the endpoint list.

Next, all the points that were stored in the list (those shown as white dots in FIG. 3 are used to calculate the location and size of the bun. A circle is calculated from each possible three-point combination, and the median center point and radius from all of these circles defines the bun's location and size.

Once all of the segments have been computed, the locator checks to see if the entire bun lies inside the image. If it does not, the bun information is discarded. If the bun is inside the image, the roundness of the bun is calculated using the minimum, maximum, and standard deviation of the radii extending to each of the edge points. Finally, the bun is added to a list of buns that will be examined in more detailed process.

Referring to FIG. 4, it illustrates processing to determine bun shape. Once the buns are located, an analysis of their shape is performed to determine how circular they actually are. The square of the eccentricity may be to determine the shape of the bun. The calculation is determined by using radial scan lines that start at 50% away from the center of the bun and extend a distance of 150% away from the center of the bun, for example. A scan line exists in 10° intervals around the bun, for example. Once scan lines are created, they are traversed from the center of the bun outward until the edge of the bun is found. This distance is recorded as a radius of the bun, and is stored in a vector with previously calculated radii. A second pass is conducted, searching inward from the max extent of the scan line until the bun edge is found. This distance from the center to this point is calculated and stored in a second vector of radii. Then, the radii for each scan line are compared and if the difference between the two does not meet a specific tolerance (currently 15), then the scan line is ejected as unreliable. Finally, an average of all the values on a scan line is taken. If this average value is too high (currently 85 or greater), for example, then the line is ejected as most likely containing another bun causing interference. After all the tests are performed, the remaining radii for each scan line are averaged and placed in a new vector. This vector is then sorted, and the major and minor radii of the bun are extracted from it. Finally, the square of the eccentricity, which is 1−minor²/major², is calculated.

Referring to FIG. 5, it illustrates processing to detect defects. The classifier 32 comprises algorithms that perform image processing that quantifies the various defects and performs classification. This is encapsulated in the process class. The bun is segmented into regions for processing. Based on the data extracted, the classifier 32 makes a reject decision on the bun and sets the failed bun flag in the bun class. The input is the list of bun locations for each bun in the bun class list.

Exemplary further processing performed by the classifier 32 performs subimage, zone, and region segmentation processing. The first step is to extract each subimage that contains a complete bun from the original image based on the bun data in the locator class. This subimage consists of a rectangle that is just large enough to contain the bun and the immediate background.

An exemplary edge zone extends about 0.5″-0.75″ in from the perimeter of the bun all the way around. This part of the bun contains crescent or heel break and shred defects. Also, the tolerance for color deviation and seeding voids in this zone is more lenient than in the rest of the bun. As a result the thresholds for what is considered a defective bun may be different here than in the center of the bun.

The second zone is the remainder center part of the bun. This is the area of primary concern when looking for the rest of the defects. In order to establish the variability in color and seeding distributions across the buns, it is necessary to segment this center zone into smaller areas where local values can be calculated. A comparison across all the local values gives an indication of the uniformity of the product with respect to the types of defects that are being identified.

The approach used in the reduced to practice embodiment is to subdivide the entire subimage (not just the center zone) into regions, but only consider those regions that are in the center zone of the bun. The regions are generally the same size for valid comparisons, and they are approximately the same size across all the buns in the list (as much as is possible). For simplicity the regions are constrained to be square, and the number of regions are fixed in the subimage to be constant.

The defect detection algorithm performs a subimage line-by-line scan of every pixel within the bun boundary as established by the locator 31. Based on the location of the pixel it is processed using the edge zone criteria or the center zone criteria. Local statistics are aggregated based on the region membership. In other words, all the pixels in a particular region are used to generate the statistics for that particular region. The values that result are

$$Local Stats \text{:} \qquad \frac{total \# defect A pixels in region}{total \# pixels in region} = Local \% defect A .$$

This will be done for each defect type. The overall statistics will simply be the average of the local statistics.

$$Overall Stats \text{:} \qquad \frac{\sum local \% defect A}{total \# regions} = Overall \% defect A .$$

If a region contains more than one zone (at the boundary of the edge and center zone), then two separate sets of statistics will need to be retained for that region (one for each zone). In this case the denominator (total # or pixels) will not be per region, but rather total number of pixels per zone in that region. It is very important that careful bookkeeping is kept in order to ensure that the results remain accurate. The edge zone, the defect detection algorithm looks for crescent, local and overall color variation, grease, and foreign matter. All of this data is stored in the bun class.

Exemplary center zone criteria for the bun are the following: overall average bake level/color, bake level/color distribution, garnish count and distribution, residual flour, blisters, punctures, grease, upside down buns, and other contaminants. The extracted features are stored in the bun class either as the ratios for that defect, or simply as a binary true/false flag for the presence of the defect types. This data is used in the classification stage (classifier 32) to make an overall assessment of the bun.

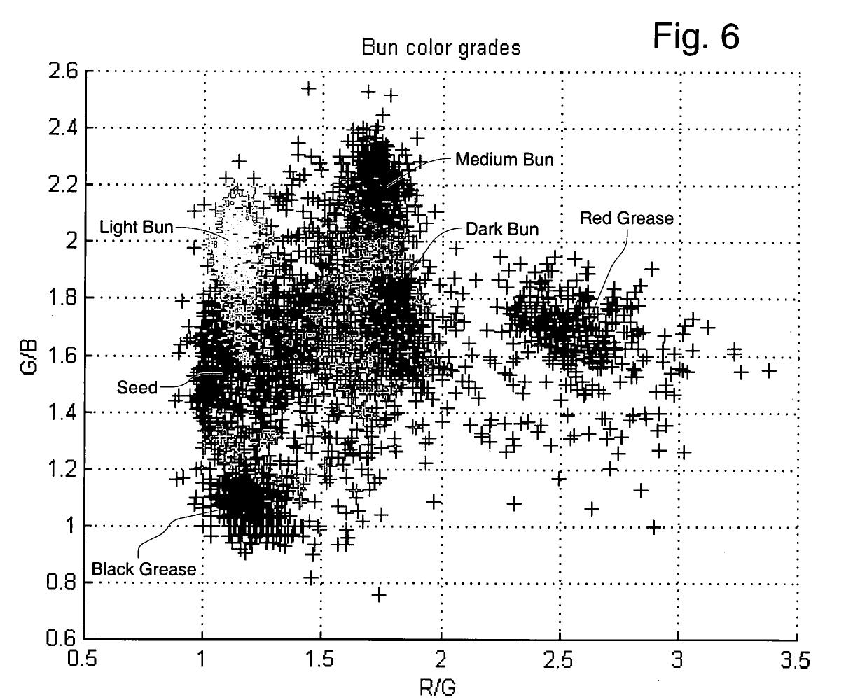

The processing for each zone may be implemented using a colorspace decision boundary. Based on the relationship between the RGB pixel values, each pixel is classified as either a defect type or as a good pixel. For the sake of speed and flexibility, this may be implemented using a lookup table into the RGB colormap to determine the class membership. FIG. 6 is a graph that illustrates statistics regarding exemplary bun color grades.

Once the pixels have been classified, the overall bun color may be determined. To do this, each color grade is assigned a number: light pixels are 1, medium pixels are 50, and dark pixels are 100, for example. Then, for each region, an average color may be calculated using the following formula:

$$color = \frac{1 * \# light pixels + 50 * \# medium pixels + 100 * \# dark pixels }{total color pixels} .$$

This equation gives a weighted average, so values less than 50 are lighter regions, and values greater that 50 are darker regions. The mean of these regional color values is then calculated, giving the overall color of the bun.

An alternative way of calculating the average color of the bun is to use the average L*a*b* color values of the bun. In this representation, the L value is what represents the actual color of the bun. To calculate this, the red, green, and blue values are found for each pixel in the bun that is considered a bun pixel (instead of a garnish pixel, grease, etc.). Once these values are obtained, they are averaged to arrive at the average RGB value for the bun. Next the RGB values are converted to an XYZ color space, which are converted to the L*a*b* color space. The conversion formula implements matrix multiplication and is given below:

$$\begin{matrix}[ X ] \\ [ Y ] \\ [ Z ]\end{matrix} = \begin{matrix}[ 0.412453 & 0.357580 & 0.180423 ] \\ [ 0.212671 & 0.715160 & 0.072168 ] \\ [ 0.019334 & 0.119193 & 0.950226 ]\end{matrix} \begin{matrix}[ R ] \\ [ G ] \\ [ B ] .\end{matrix}$$

A white reference value is needed to convert from XYZ to L*a*b*. A reference RGB value of 255, 255, 255, for example, is then converted to XYZ. The reference values are referred to as Xn, Yn, Zn. The XYZ to L*a*b* conversion is listed below.
L*=116*(Y/Yn)^{1/3}−16 for Y/Yn>0.008856
L*=903.3*Y/Yn otherwise
a*=500*(f(X/Xn)−f(Y/Yn))
b*=200*(f(Y/Yn)−f(Z/Zn))

where f(t)=t^{1/3} for t>0.00856
f(t)=7.787*t+16/116 otherwise.

Next, the color distribution is calculated. The mean and variance of the percentage of each color in the regions are calculated. There is an average light percentage, average medium percentage, average dark percentage, and variances for light, medium, and dark. The greatest mean of the three is found, which indicates the color class covering the most of the bun, the associated variance as the color distribution is used. Variance rather than standard deviation is used because, although they are essentially the same information, the variance gives better resolution as well as eliminating a square root computational operation.

Along with color values, seed coverage and distribution are calculated. This algorithm first examines all of the regions that lie entirely within the center zone, ignoring any regions that include areas from the edge zone. The percentage of seed pixels in each region is considered the seed count of that region, and the mean of these counts over all regions is calculated and stored in the bun class as the overall seed count. As with the color distribution, the seed distribution is simply the variance of the seed counts of all the regions.

After the bun class has been populated with the defect percentages and flags, an overall assessment must be made for each bun using this data. The bun classifier 32 determines the overall ultimate grade. The simplest form of decision in this case is a hard threshold for each category. If any defect class exceeds the maximum allowable threshold, the product is downgraded. This could lead to passing buns that would not fail any category outright, but as a whole are unacceptable because of the combination of smaller defect quantities. In this case a more complicated fuzzy logic procedure may be used to perform the classification. In the end result a “pass/fail” grade is assigned to each bun. This gets indicated in the bun class.

Referring now to FIGS. 7-9, they illustrate additional details of the exemplary bread grading system 10, and in particular, details of image acquisition components located in the housing 21. More specifically, FIG. 7 shows a side view of the image acquisition portion of the system 10, FIG. 8 shows an end view of the image acquisition portion of the system 10, and FIG. 9 shows details of the illumination devices 23 comprising the lighting system 23 used in the system 10.

The housing 21 comprises an imaging dome that houses the cameras 22 and lighting system 23 (illumination devices 23) to support overline imaging for product inspection and monitoring. The geometry of the imaging dome (cylindrical) is designed to optimize the uniformity of the light in the field of view. The illumination devices 23 do not directly illuminate the field of view, but rely on the reflections and the geometry of the dome to achieve uniform illumination. The illumination devices 23 may be conventional compact fluorescent light bulbs or high intensity LEDs, for example. The dome is preferably sealed for water resistance and is preferably constructed of stainless steel or other materials approved for contact with food.

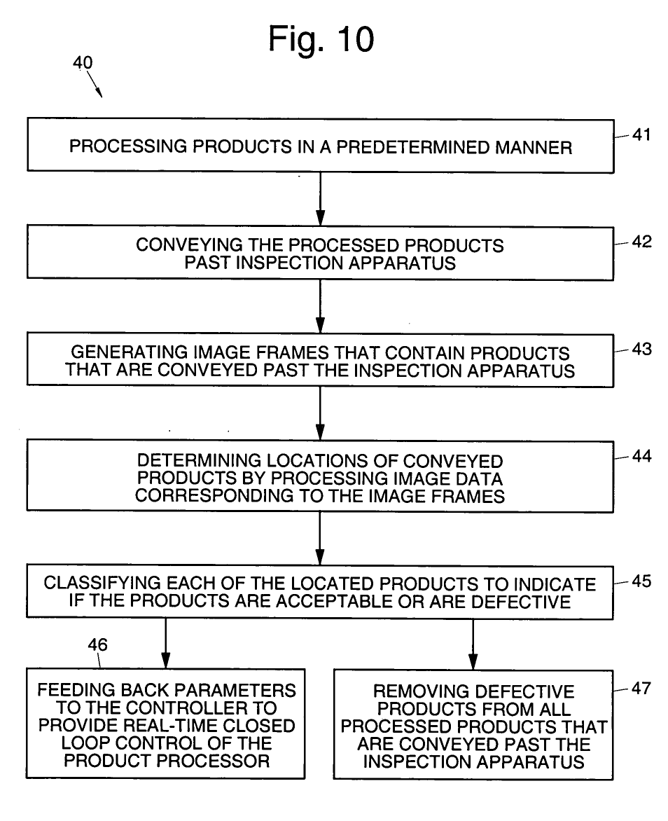

FIG. 10 illustrates an exemplary product inspection method 40. The exemplary product inspection method 40 is implemented as follows.

Products are processed 41 in a predetermined manner, such as by cooking, baking, or sorting, for example. The processed products are conveyed 42 past inspection apparatus 20. Image frames are generated 43 that contain products that are conveyed past the inspection apparatus 20. Locations of conveyed products are determined 44 by processing image data corresponding to the image frames. Each of the located products are classified 45 to indicate if the products are acceptable or are defective. Parameters are fed back 46 to the controller to provide real-time closed-loop control of the products that are processed. Defective products are removed 47 from processed products that are conveyed past the inspection apparatus 20.

While the above described systems and method are directed to bun baking production lines, it is to be understood that other products may readily be monitored, inspected and controlled using the principles discussed above. For example, raw and cooked meat and vegetables, eggs, and package inspection and control may readily be accomplished using the principles discussed above.

Details regarding these addition applications are as follows. For example, a system monitoring fully cooked meat products must monitor the minimum internal core temperature in addition to the surface color properties measured for bread. This parameter is widely used to verify the level of dangerous pathogens has been reduced to safe levels. For this application, an infrared camera that measures product surface temperature can be used in conjunction with the color camera used to measure final product color and defects. The surface temperatures are correlated with internal core temperatures and product dependent relationships between these parameters can be used to estimate the core temperatures from the surface temperature measurements. In addition to providing a core temperature estimate, the temperature data collected by the camera may also be used to aide the locator in finding pieces of product. For example a color ratio may be used in conjunction with a temperature threshold to increase the accuracy of the scanline calculation used to detect products.

Thus, automated vision-based systems and methods for monitoring, inspecting and controlling baking and cooking processes, and the like, have been disclosed. It is to be understood that the above-described embodiments are merely illustrative of some of the many specific embodiments that represent applications of the principles discussed above. Clearly, numerous and other arrangements can be readily devised by those skilled in the art without departing from the scope of the invention.

What is claimed is:

1. Apparatus, comprising:
a product processor;
a controller for controlling operation of the product processor;
a conveyor for moving products processed by the product processor;
inspection apparatus disposed adjacent to the conveyor that comprises:
an image acquisition system for generating images of products conveyed by the conveyor; and
an inspection processor coupled to the image acquisition system for processing images generated by the image acquisition system to inspect the products conveyed by the conveyor and feeding back parameters to the controller to provide closed loop control of the product processor.

2. The apparatus recited in claim 1 wherein the product processor has multiple heating zones that are controlled by the controller and wherein the inspection processor couples signals to the controller that control the temperatures of the heating zones.

3. The apparatus recited in claim 1 further comprising one or more illumination devices for illuminating products disposed on the conveyor.

4. The apparatus recited in claim 1 further comprising a kickoff device for removing product from the conveyor, and wherein the inspection processor couples signals to the kickoff device to remove selected products from the conveyor.

5. The apparatus recited in claim 4 wherein the inspection processor is coupled to the kickoff device and couples control signals thereto that control operation of the kickoff device.

6. The apparatus recited in claim 1 wherein the inspection processor is coupled to a display for displaying information regarding the apparatus, and to a database for storing data relating to the products that are inspected.

7. The apparatus recited in claim 1 wherein the inspection processor is operative to determine parameters selected from a group including product location, product color distribution, product roundness, garnish cover and uniformity, total number of products processed, number of product processed per minute, and percentage of defective products.

8. The apparatus recited in claim 1 wherein the inspection processor implements algorithms that:
determines locations of products in image frames received from the image acquisition system and outputs a list of products;
processes the image frames and the list of products to classify and analyzes products that were located by the locator; and
computes running statistical quantities relating to the products in the list of products.

9. The apparatus recited in claim 1 wherein the wherein the inspection processor further comprises:
a remover coupled to the kickoff device for generating a control signal that causes the kickoff device to remove defective products from the conveyor.

10. The apparatus recited in claim 1 wherein the inspection processor is coupled to a display that allows viewing of the images of products conveyed by the conveyor and the statistics output by the aggregator.

11. The apparatus recited in claim 8 wherein the inspection processor is coupled to a database that stores the running statistical quantities relating to the inspected products.

12. The apparatus recited in claim 5 wherein the product processor comprises an oven, the controller comprises an oven controller for controlling operation of the oven, and the conveyor is operative to move products through the oven and past the apparatus.

13. Apparatus, comprising:
a product processor;
a controller for controlling operation of the product processor;
a conveyor for moving products processed by the product processor;
a kickoff device coupled to the inspection processor for removing product from the conveyor; and
inspection apparatus disposed adjacent to the conveyor that comprises:
an image acquisition system for generating images of products conveyed by the conveyor;
one or more illumination devices for illuminating products disposed on the conveyor; and
an inspection processor coupled to the image acquisition system for processing images generated by the image acquisition system to inspect the products conveyed by the conveyor, and feeding back parameters to the controller to provide real-time closed loop control of the product processor.

14. The apparatus recited in claim 13 wherein the inspection processor is coupled to a display for displaying information regarding the apparatus, and to a database for storing data relating to the products that are inspected.

15. A method comprising:
processing products in a predetermined manner;
conveying the processed products past inspection apparatus;
generating image frames that contain products that are conveyed past the inspection apparatus;
determining locations of conveyed products by processing image data corresponding to the image frames;
classifying each of the located products to indicate if the products are acceptable or are defective; and
feeding back parameters to the controller to provide closed-loop control of the products that are processed.

16. The method recited in claim 15 further comprising removing defective products from processed products that are conveyed past the inspection apparatus.

17. The method recited in claim 15 wherein the predetermined manner of processing the products is selected from a group including cooking, baking, and sorting.

18. The method recited in claim 15 further comprising controlling processing of the products based upon how the products are classified.

19. The method recited in claim 15 wherein the further comprising controlling heating zones that are used to process the products.

20. The method recited in claim 15 further comprising viewing images of products conveyed past the inspection apparatus and statistics relating to inspected products.
